(19) United States
(12) Patent Application Publication
(10) Pub. No.: US 2025/0358486 A1
(43) Pub. Date: Nov. 20, 2025

(54) VIDEO CONTENT PROCESSING

(71) Applicants: Beijing Zitiao Network Technology Co., Ltd., Beijing (CN); Lemon Inc., Grand Cayman (KY)

(72) Inventors: Lelai DENG, Beijing (CN); Kang WANG, Beijing (CN); Xudong LIU, Beijing (CN); Yi-Sheng LIN, Beijing (CN); Ruyun LI, Beijing (CN); Yuanzhe CHEN, Beijing (CN); Yuanyuan HUO, Beijing (CN); Zhuo CHEN, Los Angeles, CA (US); Yuping WANG, Beijing (CN)

(21) Appl. No.: 19/207,152

(22) Filed: May 13, 2025

(30) Foreign Application Priority Data
May 14, 2024 (CN) 202410599576.8

(51) Int. Cl. H04N 21/81; G06F 40/40; H04N 21/439; H04N 21/44

(52) U.S. Cl. CPC H04N 21/8106; G06F 40/40; H04N 21/4394; H04N 21/44008; H04N 21/816

(57) ABSTRACT

The embodiment of the disclosure relates to methods, apparatuses, devices, and storage media for processing video content. The method provided herein includes: generating a set of audio tokens corresponding to first audio content of first video content, the first audio content corresponding to first text content of a first language; generating, based on an audio feature representation corresponding to the set of audio tokens, second audio content corresponding to second text content, the second text content being generated by translating the first text content into a second language; generating a second set of video frames based on a set of visual features corresponding to a first set of video frames of the first video content and the audio feature representation; and generating second video content based on the second set of video frames and the second audio content.

### CROSS-REFERENCE

The present application claims priority to Chinese Patent Application No. 202410599576.8, filed on May 14, 2024, and entitled “METHOD, APPARATUS, DEVICE AND STORAGE MEDIUM FOR PROCESSING VIDEO CONTENT”, the entirety of which is incorporated herein by reference.

### FIELD

Example embodiments of the present disclosure generally relate to the field of computers, and in particular, to video content processing.

### BACKGROUND

With the development of computer technologies, the Internet has become an important platform for information interaction for people. For example, people can perform video content propagation through an Internet platform, but in a cross-language scenario, audio in video content needs to be translated and dubbed across languages, so that the video content can be propagated in a larger range.

### SUMMARY

In a first aspect of the present disclosure, a method for processing video content is provided. The method comprises: generating a set of audio tokens corresponding to first audio content of first video content, the first audio content corresponding to first text content of a first language; generating, based on an audio feature representation corresponding to the set of audio tokens, second audio content corresponding to second text content, the second text content being generated by translating the first text content into a second language; generating a second set of video frames based on a set of visual features corresponding to a first set of video frames of the first video content and the audio feature representation; and generating second video content based on the second set of video frames and the second audio content.

In a second aspect of the present disclosure, an apparatus for processing video content is provided. The apparatus comprises: a first generation module, configured to generate a set of audio tokens corresponding to first audio content of first video content, the first audio content corresponding to first text content of a first language; a second generation module, configured to generate, based on an audio feature representation corresponding to the set of audio tokens, second audio content corresponding to second text content, the second text content being generated by translating the first text content into a second language; a third generation module, configured to generate a second set of video frames based on a set of visual features corresponding to a first set of video frames of the first video content and the audio feature representation; and a fourth generation module, configured to generate second video content based on the second set of video frames and the second audio content.

In a third aspect of the present disclosure, an electronic device is provided. The device comprises at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer-readable storage medium stores a computer program thereon, the computer program being executable by a processor to implement the method of the first aspect.

It should be understood that the content described in this Summary section is not intended to limit the key features or important features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure can be implemented;

FIG. 2 shows a flowchart of the process of example processing video content according to some embodiments of the present disclosure;

FIGS. 3A-3C show schematic diagrams of the process of example processing video content according to some embodiments of the present disclosure;

FIG. 4 illustrates a schematic structural block diagram of an example processing video content apparatus according to some embodiments of the present disclosure; and

FIG. 5 illustrates a block diagram of an electronic device capable of implementing one or more embodiments of the present disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms and should not be construed as limited to the embodiments set forth herein, but rather, these embodiments are provided for a more thorough and complete understanding of the disclosure. It should be understood that the drawings and embodiments of the disclosure are for example purposes only and are not intended to limit the scope of the disclosure.

It should be noted that the title of any section/subsection provided herein is not limiting. Various embodiments are described throughout and any type of embodiments may be included in any section/subsection. Furthermore, the embodiments described in any section/subsection may be combined with any other embodiment described in the same section/subsection and/or different sections/subsections in any manner.

In the description of the embodiments of the disclosure, the terms “comprising”, “including” and the like should be understood to open-ended, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, processed, forwarded, used, etc., all of which are performed on the premise that the user knows and confirms. Accordingly, when implementing the embodiments of the present disclosure, the user should be informed of the types, use ranges, usage scenario, and the like of the data or information that probably involved in an appropriate manner according to relevant laws and regulations and the authorization of the user may be obtained. The specific notification and/or authorization manner may vary according to actual situations and application scenarios, and the scope of the present disclosure is not limited in this respect.

The solutions in the present specification and the embodiments, if personal information processing is involved, may be processed on the premise of having a legality basis (for example, obtaining consent of a personal information subject, or necessary for performing a fulfillment contract), and shall be processed only within a specified or agreed range. The user rejecting personal information other than necessary information required for the basic function would not affect the basic function of the user.

According to a conventional solution, one solution is that audio and video translation and dubbing (hereinafter referred to simply as translation & dubbing) are usually performed by professional translators, although the method has a better dubbing effect, but the cost is too high. Another solution needs to strip out the audio that needs to be Translated and dubbed, and obtain the transcription text corresponding to the original language by using an Automatic Speech Recognition (ASR) technology; then obtain the text of the target language by using a Neural Machine Translation (NMT); and finally obtain the final translated and dubbed audio through a Text to Speech (TTS) system, and finally obtain the final cross-language translation and dubbing video after the video synthesis.

The final cross-language translation and dubbing video obtained based on the above solution has some following defects: (1) most existing turnover systems adopt a concatenated solution, and the sound effect, the video picture, the background music and the speaking sound are processed separately, which leads to the fact that the final synthesized video lacks information interaction between respective elements, and the effect is not natural. (2) Under the ASR-NMT joint system, the obtained target language text will exhibit a phenomenon of lengthening or shortening the length of the speech, therefore the speech speed is accelerated or even the speech is truncated when the dubbing is performed, and the final translation and dubbing effect is affected; the traditional TTS method is deficient in tone similarity, and the control degree of accent is not ideal enough. (3) Most of the existing translation and dubbing systems do not take into account the matching of mouth shape with the speaking person type in the video and the corresponding modification, which leads to mismatch of mouth shape of the translation and dubbing video, and the overall translation and dubbing video experience is not ideal enough.

Embodiments of the present disclosure provide a solution for processing video content. According to the solution, a set of audio tokens corresponding to first audio content of first video content may be generated, the first audio content corresponding to first text content of a first language; generating, based on an audio feature representation corresponding to the set of audio tokens, second audio content corresponding to second text content, the second text content being generated by translating the first text content into a second language; generating a second set of video frames based on a set of visual features corresponding to a first set of video frames of the first video content and the audio feature representation; and generating second video content based on the second set of video frames and the second audio content.

In this way, the embodiments of the present disclosure are able to support the to-be-translated and dubbed video, which is based on the user input, and directly output the video that has been translated and dubbed, thereby reducing the threshold for audio and video translation and dubbing, and improving the efficiency and naturalness of audio and video translation and dubbing.

Various example implementations of this solution are described in detail below in conjunction with the accompanying drawings.

### Example Environment

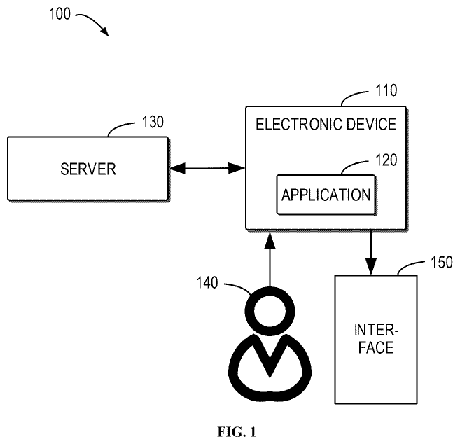

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run with an application 120 that supports interface interaction. The application 120 may be any suitable type of application for interface interaction, examples of which may include, but are not limited to, a video editing application or other suitable application. The user 140 may interact with the application 120 via the electronic device 110 and/or its attachment device.

In the environment 100 of FIG. 1, if the application 120 is active, the electronic device 110 may present, through the application 120, an interface 150 for supporting interface interaction.

In some embodiments, the electronic device 110 communicates with the server 130 to enable provisioning of services to the application 120. Electronic device 110 may be any type of mobile terminals, fixed terminals, or portable terminals, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be an independent physical server, may also be a server cluster or a distributed system formed by a plurality of physical servers, and it may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for applications 120 that support content presentation in the electronic device 110.

A communication connection may be established between the server 130 and the electronic device 110. The communication connection may be established in a wired manner or a wireless manner. Communication connections may include, but are not limited to, Bluetooth connections, mobile network connections, universal serial bus connections, wireless fidelity connections, etc., embodiments of the present disclosure are not limited in this respect. In an embodiment of the present disclosure, the server 130 and the electronic device 110 may implement signaling interaction through a communication connection between the server 130 and the electronic device 110.

It should be understood that the structures and functions of the various elements in environment 100 are described for example purposes only and do not imply any limitation to the scope of the disclosure.

### Example Process

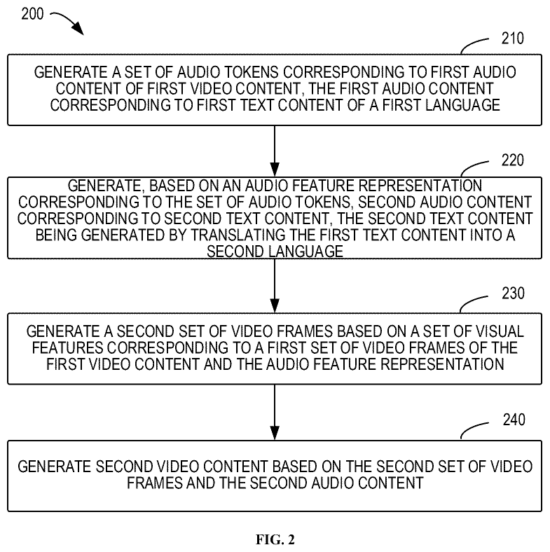

FIG. 2 illustrates a flowchart of the process 200 of example processing video content according to some embodiments of the present disclosure. The process 200 may be implemented at electronic device 110. The process 200 is described below with reference to FIG. 1.

As shown in FIG. 2, at block 210, the electronic device 110 generates a set of audio tokens corresponding to first audio content of first video content, the first audio content corresponding to first text content of a first language.

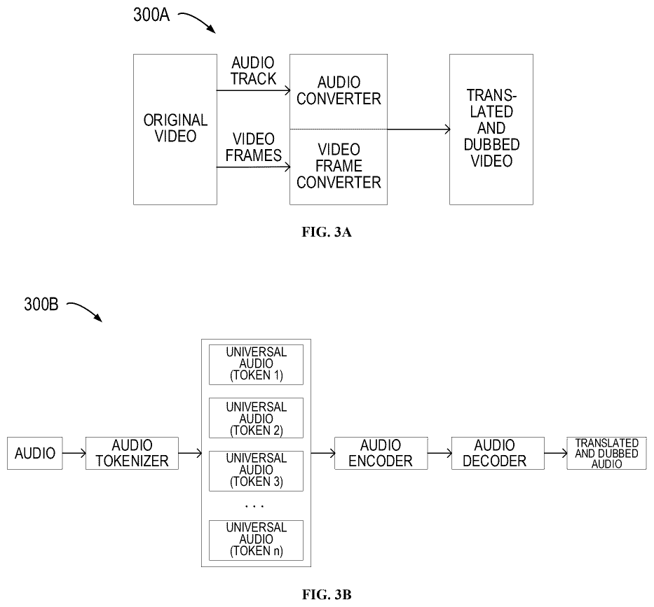

In some embodiments, referring to FIG. 3A, first video content is the to-be-translated and dubbed original video content inputted by the user. The electronic device 110 may obtain first audio content of the first video content based on the first video content inputted by the user. The first audio content is the first text content extracted from the first video content. The first audio content may be, for example, audio content such as voice, sound effect, background music in the first video content.

In some embodiments, the electronic device 110 may perform processing on the first audio content based on the audio converter model. With continued reference to FIG. 3A and FIG. 3B, the electronic device 110 may obtain, based on an audio tokenizer in the audio converter model, a plurality of audio tokens corresponding to a plurality of segments of the first audio content, the plurality of audio tokens may be universal audio tokens (UATs). Such a set of universal audio tokens may be represented, for example, as a universal audio token 1, a universal audio token 2, a universal audio token 3, . . . , a universal audio token n.

In this way, the electronic device 110, based on the audio tokenizer in the audio converter model, unifies the speech, the sound effect, the background music, and the like in the first audio content into a set of universal audio tokens for processing, so as to have a better control on the length, expression, and speech speed after final translation and dubbing.

At block 220, the electronic device 110 generates, based on an audio feature representation corresponding to the set of audio tokens, second audio content corresponding to second text content, the second text content being generated by translating the first text content into a second language.

In some embodiments, with continued reference to FIG. 3B, the electronic device 110 performs information compression on the set of universal audio tokens obtained via the audio encoder in the audio converter model, to obtain an audio feature representation corresponding to the set of universal audio tokens.

In some embodiments, the electronic device 110 processes the obtained audio feature representation via an audio decoder in the audio converter model. Such processing task may be, for example, translating the first text content into the second text content, aligning the first duration of the first audio content with the second duration of the second audio content. Thereby, the decoded second audio content after translation and dubbing is finally obtained through decoding.

At block 230, the electronic device 110 generates a second set of video frames based on a set of visual features corresponding to a first set of video frames of the first video content and the audio feature representation.

In some embodiments, with continued reference to FIG. 3A, the electronic device 110 may further obtain, based on the first video content inputted by the user, a first set of video frames sequence of the first video content, for example, a video frame 1, a video frame 2, a video frame 3, . . . , a video frame n.

In some embodiments, the electronic device 110 may process the first set of video frames sequence based on the video converter model. With continued reference to FIG. 3A and FIG. 3C, the electronic device 110 may obtain, based on the video image encoder in the video converter model, a set of visual features corresponding to the first set of video frames sequence, e.g., a sequence of video frame embedding 1, video frame embedding 2, video frame embedding 3, . . . , video frame embedding n. Here, the video converter may be a video frame converter.

In some embodiments, the electronic device 110 determines, based on the time information of the first video frame (for example, the video frame 1) in the first set of video frames sequence, a feature segment corresponding to the first video frame from the audio feature representation, and uses the feature segment as the auxiliary information.

In some embodiments, the electronic device 110 sends the auxiliary information and the first visual feature (for example, the video frame embedding 1) of the first video frame to a video frame decoder of the video frame converter model to generate a second video frame (for example, the video frame 1′) corresponding to the first video frame. The main task of the video frame decoder is to correct and align the person's mouth shape in the first set of video frames to finally obtain the second set of video frames sequence adapted to the translation and dubbing audio.

In some embodiments, the audio converter and the video converter may be systematically trained.

In this way, based on the video frame converter model, the electronic device 110 uses the output of the audio encoder as the auxiliary information to adjust the mouth shape related to the speaker, so that the mouth shape matches the second audio content, and the naturalness of the final translated and dubbed video is improved.

At block 240, the electronic device 110 generates second video content based on the second set of video frames and the second audio content.

In some embodiments, the electronic device 110 combines the second audio content with a second set of video frames sequences adapted to the first audio content to obtain a final translated and dubbed video, i.e., the second video content.

In this way, the electronic device 110 passes, based on the first video content inputted by the user, the first audio content of the first video content and the first set of video frames sequence through the audio converter model and the video frame converter model simultaneously, and outputs the final translated and dubbed video (the second video content). In the audio converter model, the speech, the sound effect, and the background music of the first audio content are all coded in the form of a universal audio token, so that the generated translated and dubbed audio is closer to the original audio (the first video content) in the speech timbre, the expression, the sound effect, and the background sound distribution. In an end-to-end audio translation and dubbing system, accent and length are also better adapted. For the video frame, the audio encoding result is used as the auxiliary information, and the mouth shape is adaptively adjusted when the video frame is decoded, so that the video after translation and dubbing is more natural, and the translated and dubbed video experience is improved.

In summary, based on the end-to-end converter framework, the whole translation and dubbing process is no longer split units. Instead, it directly outputs, based on the to-be-translated and dubbed video inputted by the user, the video that has been translated and dubbed, so that the threshold for audio and video translation and dubbing is reduced, and the audio and video translation and dubbing efficiency and naturalness are improved. Moreover, based on the automatic video translation and dubbing production process, the labor cost and the time cost can be reduced.

### Example Apparatus and Device

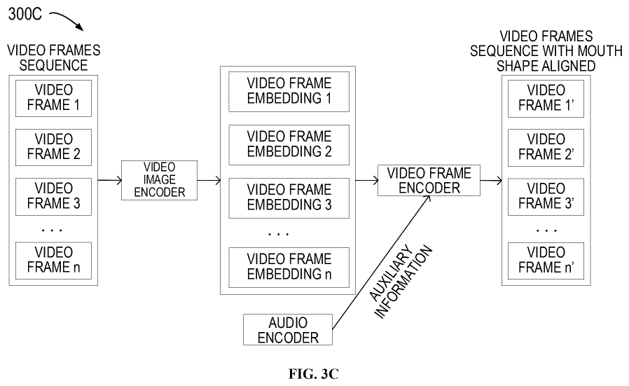

Embodiments of the present disclosure also provide a corresponding apparatus for implementing the above method or process. FIG. 4 illustrates a schematic structural block diagram of an example processing video content apparatus 400 according to some embodiments of the present disclosure. The apparatus 400 may be implemented as the electronic device 110 or included in the electronic device 110. The various modules/components in the apparatus 400 may be implemented by hardware, software, firmware, or any combination thereof.

As shown in FIG. 4, the apparatus 400 comprises a first generation module 410, configured to generate a set of audio tokens corresponding to first audio content of first video content, the first audio content corresponding to first text content of a first language; a second generation module 420, configured to generate, based on an audio feature representation corresponding to the set of audio tokens, second audio content corresponding to second text content, the second text content being generated by translating the first text content into a second language; a third generation module 430, configured to generate a second set of video frames based on a set of visual features corresponding to a first set of video frames of the first video content and the audio feature representation; and a fourth generation module 440, configured to generate second video content based on the second set of video frames and the second audio content.

In some embodiments, the third generation module 430 is specifically configured to: for a first video frame in the first set of video frames, determine, based on the time information of the first video frame, a feature segment corresponding to the first video frame from the audio feature representation; and generate, based on a first visual feature of the first video frame and the feature segment, a second video frame corresponding to the first video frame.

In some embodiments, the second audio content is generated using an audio converter in a target model, the second set of video frames are generated using a video converter in the target model, and the audio converter and the video converter are co-trained.

In some embodiments, the second video content has a mouth shape change corresponding to the second audio content.

In some embodiments, the first generation module 410 is specifically configured to extract the first audio content from the first video content; and generate, using an audio tokenizer, a plurality of audio tokens corresponding to a plurality of segments of the first audio content, the audio token being a universal audio token (UAT).

In some embodiments, the second generation module 420 is specifically configured to generate, using an audio encoder, an audio feature representation corresponding to the set of audio tokens; and process, using an audio decoder, the audio feature representation to generate the second audio content.

In some embodiments, the audio decoder is configured to perform at least one of the following tasks: a first task, configured to translate the first text content into the second text content; a second task, configured to align a first duration of the first audio content and a second duration of the second audio content.

The modules included in the apparatus 400 may be implemented in various forms, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

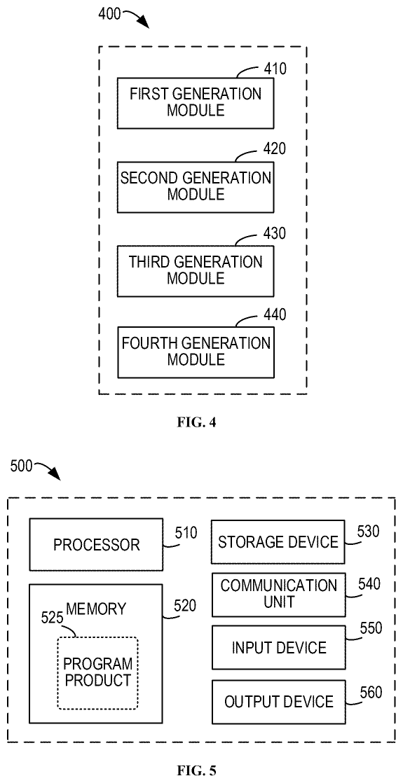

FIG. 5 illustrates a block diagram of an electronic device 500 capable of implementing one or more embodiments of the present disclosure. It should be understood that the electronic device 500 shown in FIG. 5 is merely for example and should not constitute any limitation on the function and scope of the embodiments described herein. The electronic device 500 shown in FIG. 5 may be configured to implement the electronic device 110 of FIG. 1.

As shown in FIG. 5, the electronic device 500 is in the form of a general-purpose electronic device. Components of the electronic device 500 may include, but are not limited to, one or more processors or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve parallel processing capabilities of electronic device 500.

The electronic device 500 typically includes a plurality of computer storage media. Such media may be any available media accessible by the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communications unit 540 implements communications with other electronic devices over a communications medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

1. A method for processing video content, comprising:
generating a set of audio tokens corresponding to first audio content of first video content, the first audio content corresponding to first text content of a first language;
generating, based on an audio feature representation corresponding to the set of audio tokens, second audio content corresponding to second text content, the second text content being generated by translating the first text content into a second language;
generating a second set of video frames based on a set of visual features corresponding to a first set of video frames of the first video content and the audio feature representation; and
generating second video content based on the second set of video frames and the second audio content.

2. The method of claim 1, wherein generating the second set of video frames based on the set of visual features corresponding to the first set of video frames of the first video content and the audio feature representation comprises:
determining, for a first video frame of the first set of video frames and based on time information of the first video frame, a feature segment corresponding to the first video frame from the audio feature representation; and
generating, based on a first visual feature of the first video frame and the feature segment, a second video frame corresponding to the first video frame.

3. The method of claim 1, wherein the second audio content is generated using an audio converter in a target model, the second set of video frames are generated using a video converter in the target model, and the audio converter and the video converter are co-trained.

4. The method of claim 1, wherein the second video content has a mouth shape change corresponding to the second audio content.

5. The method of claim 1, wherein generating the set of audio tokens corresponding to the first audio content of the first video content comprises:
extracting the first audio content from the first video content; and
generating, using an audio tokenizer, a plurality of audio tokens corresponding to a plurality of segments of the first audio content, the audio token being a universal audio token (UAT).

6. The method of claim 1, wherein generating, based on the audio feature representation corresponding to the set of audio tokens, the second audio content comprises:
generating, using an audio encoder, an audio feature representation corresponding to the set of audio tokens; and
processing, using an audio decoder, the audio feature representation to generate the second audio content.

7. The method of claim 6, wherein the audio decoder is configured to perform at least one of the following tasks:
a first task, configured to translate the first text content into the second text content;
a second task, configured to align a first duration of the first audio content and a second duration of the second audio content.

8. An electronic device, comprising:
at least one processor; and
at least one memory coupled to the at least one processor and storing instructions for execution by the at least one processor, the instructions, when executed by the at least one processor, causing the electronic device to perform act comprising:
generating a set of audio tokens corresponding to first audio content of first video content, the first audio content corresponding to first text content of a first language;
generating, based on an audio feature representation corresponding to the set of audio tokens, second audio content corresponding to second text content, the second text content being generated by translating the first text content into a second language;
generating a second set of video frames based on a set of visual features corresponding to a first set of video frames of the first video content and the audio feature representation; and
generating second video content based on the second set of video frames and the second audio content.

9. The electronic device of claim 8, wherein generating the second set of video frames based on the set of visual features corresponding to the first set of video frames of the first video content and the audio feature representation comprises:
determining, for a first video frame of the first set of video frames and based on time information of the first video frame, a feature segment corresponding to the first video frame from the audio feature representation; and
generating, based on a first visual feature of the first video frame and the feature segment, a second video frame corresponding to the first video frame.

10. The electronic device of claim 8, wherein the second audio content is generated using an audio converter in a target model, the second set of video frames are generated using a video converter in the target model, and the audio converter and the video converter are co-trained.

11. The electronic device of claim 8, wherein the second video content has a mouth shape change corresponding to the second audio content.

12. The electronic device of claim 8, wherein generating the set of audio tokens corresponding to the first audio content of the first video content comprises:
extracting the first audio content from the first video content; and
generating, using an audio tokenizer, a plurality of audio tokens corresponding to a plurality of segments of the first audio content, the audio token being a universal audio token (UAT).

13. The electronic device of claim 8, wherein generating, based on the audio feature representation corresponding to the set of audio tokens, the second audio content comprises:
generating, using an audio encoder, an audio feature representation corresponding to the set of audio tokens; and
processing, using an audio decoder, the audio feature representation to generate the second audio content.

14. The electronic device of claim 13, wherein the audio decoder is configured to perform at least one of the following tasks:
a first task, configured to translate the first text content into the second text content;
a second task, configured to align a first duration of the first audio content and a second duration of the second audio content.

15. A non-transitory computer-readable storage medium storing a computer program thereon, the computer program being executable by a processor to perform acts comprising:
generating a set of audio tokens corresponding to first audio content of first video content, the first audio content corresponding to first text content of a first language;
generating, based on an audio feature representation corresponding to the set of audio tokens, second audio content corresponding to second text content, the second text content being generated by translating the first text content into a second language;
generating a second set of video frames based on a set of visual features corresponding to a first set of video frames of the first video content and the audio feature representation; and
generating second video content based on the second set of video frames and the second audio content.

16. The non-transitory computer-readable storage medium of claim 15, wherein generating the second set of video frames based on the set of visual features corresponding to the first set of video frames of the first video content and the audio feature representation comprises:
determining, for a first video frame of the first set of video frames and based on time information of the first video frame, a feature segment corresponding to the first video frame from the audio feature representation; and
generating, based on a first visual feature of the first video frame and the feature segment, a second video frame corresponding to the first video frame.

17. The non-transitory computer-readable storage medium of claim 15, wherein the second audio content is generated using an audio converter in a target model, the second set of video frames are generated using a video converter in the target model, and the audio converter and the video converter are co-trained.

18. The non-transitory computer-readable storage medium of claim 15, wherein the second video content has a mouth shape change corresponding to the second audio content.

19. The non-transitory computer-readable storage medium of claim 15, wherein generating the set of audio tokens corresponding to the first audio content of the first video content comprises:
extracting the first audio content from the first video content; and
generating, using an audio tokenizer, a plurality of audio tokens corresponding to a plurality of segments of the first audio content, the audio token being a universal audio token (UAT).

20. The non-transitory computer-readable storage medium of claim 15, wherein generating, based on the audio feature representation corresponding to the set of audio tokens, the second audio content comprises:
generating, using an audio encoder, an audio feature representation corresponding to the set of audio tokens; and
processing, using an audio decoder, the audio feature representation to generate the second audio content.
